(19) United States
(12) Patent Application Publication
(10) Pub. No.: US 2010/0035098 A1
(43) Pub. Date: Feb. 11, 2010

(54) Using chemical shorting to control electrode corrosion during the startup or shutdown of a fuel cell

(76) Inventors: Manikandan Ramani, Latham, NY (US); Robert A. Dross, Saratoga Springs, NY (US); Leng Mao, Latham, NY (US); Bin Du, Clifton Park, NY (US)

Correspondence Address: TROP, PRUNER & HU, P.C., 1616 S. VOSS ROAD, SUITE 750, HOUSTON, TX, 77057-2631, US

(21) Appl. No.: 12/221,760

(22) Filed: Aug. 6, 2008

(51) Int. Cl. H01M 8/04; H01M 8/10; H01M 8/08

(52) U.S. Cl. 429/13; 429/23

(57) ABSTRACT

A technique that is usable with a fuel cell includes providing a fuel and oxidant mixture to a reactant chamber of the fuel cell to regulate an electrode potential of the fuel cell during startup or shutdown of the fuel cell.

### BACKGROUND

The invention generally relates to using a mixture of reducing agent and an oxidizing agent at a given electrode to generate an internal reaction, called “chemical shorting herein,” to control electrode corrosion during the startup or shutdown of a fuel cell.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell, an ethanol fuel cell and a proton exchange membrane (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° temperature range. Another type of PEM fuel cell may employ a phosphoric-acid-based polybenzimidazole (PBI) membrane that operates in the 150° to 200° C. temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a technique that is usable with a fuel cell includes providing a fuel and oxidant mixture to a reactant chamber of the fuel cell to regulate an electrode potential of the fuel cell during startup or shutdown of the fuel cell.

In another embodiment of the invention, a fuel cell system includes a fuel cell stack and a control subsystem. The control subsystem provides a fuel and oxidant mixture to a reactant chamber of the fuel cell stack to regulate electrode potentials of fuel cells of the stack during startup or shutdown.

Advantages and other features of the invention will become apparent from the following drawing, description and claims.

### BRIEF DESCRIPTION OF THE DRAWING

FIGS. 1 and 5 are schematic diagrams of fuel cell systems according to embodiments of the invention.

FIG. 2 is a flow diagram depicting a technique to control carbon corrosion during the startup of a fuel cell stack according to an embodiment of the invention.

FIG. 3 is a graph depicting a cathode interfacial potential of a cathode electrode versus a fuel flow into the cathode chamber according to an embodiment of the invention.

FIG. 4 is a graph depicting a reverse current versus a cathode interfacial potential according to an embodiment of the invention.

FIG. 6 is a flow diagram depicting a technique to control carbon corrosion during shutdown of a fuel cell stack according to an embodiment of the invention

FIG. 7 depicts performance results of different carbon corrosion control techniques.

### DETAILED DESCRIPTION

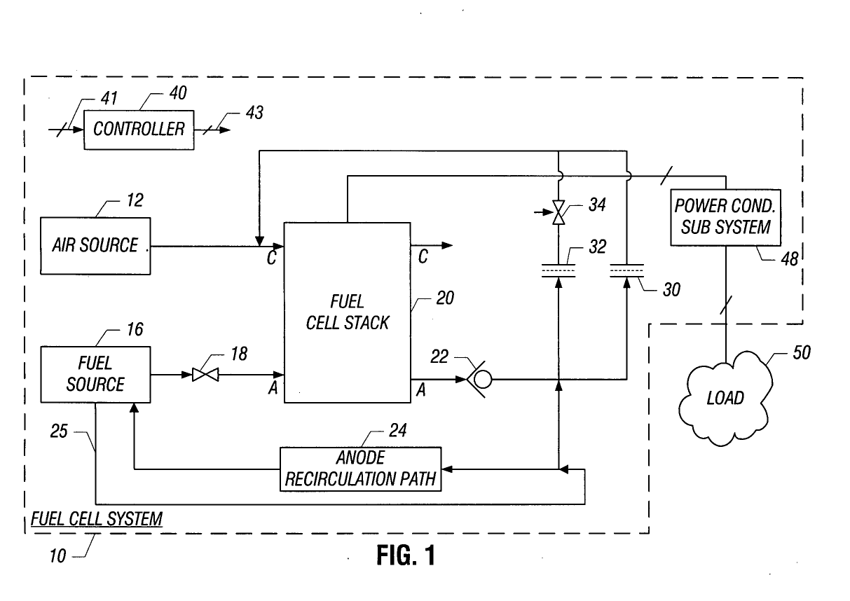

Referring to FIG. 1, a fuel cell system 10 in accordance with the invention includes a fuel cell stack 20, which produces electrical power for an external load 50 to the system 10 in response to fuel and oxidant flows that are communicated through the stack 20. As a specific example, in accordance with some embodiments of the invention, the fuel cell stack 20 includes proton exchange membrane (PEM) fuel cells. However, in accordance with other embodiments of the invention, the fuel cell stack 20 may include other types of fuel cells, such as direct methanol, direct ethanol or phosphoric acid fuel cells, as non-limiting examples.

The fuel cell system 10 and load 50 may be mobile, such as in embodiments of the invention where the load 50 is the power plant of a vehicle that incorporates the system 10. Thus, the fuel cell system 10 may be part of an automobile, truck, forklift, airplane, etc., in accordance with some embodiments of the invention. It is noted, however, that the fuel cell system 10 and load 50 may be stationary, such as embodiments of the invention in which the load 50 is a telecommunication system or a residential load. The fuel cell system 10 may, in accordance with other embodiments of the invention, be part of a portable, handheld electronic device, such as a mobile computer or cellular telephone (as non-limiting examples). More specifically, the fuel cell system 10 may, for example, be part of a charging device of the computer or cellular telephone. Thus, many variations and applications of the fuel cell system 10 beyond those listed herein are contemplated and are within the scope of the appended claims.

The fuel cell stack 20 contains flow plates that provide a structure for communicating fuel and oxidant flows to membrane electrode assemblies (MEAs) of the fuel cells. More specifically, flow plates of the fuel cell stack 20 contain flow channels, which communicate a fuel flow and collectively form the anode chamber of the stack 20; and flow plates of the fuel cell stack 20 contain flow channels, which communicate an oxidant-containing air flow and collectively form a cathode chamber of the stack 20.

When a valve 18 (a solenoid valve, for example) is open, the anode inlet of the fuel cell stack 20 receives an incoming fuel flow that is provided by a fuel source 16 (a reformer, a hydrogen tank, cartridge of direct methanol, ethanol, etc.). The incoming fuel flow is routed through the flow channels of the anode chamber and produces an anode exhaust flow that exits the fuel cell stack 20 at the stack's anode exhaust outlet. The cathode inlet of the fuel cell stack 20 receives an incoming air flow from an air source 12 (an air blower, for example). The incoming air flow is routed through the flow channels of the cathode chamber and produces a cathode exhaust flow that exits the fuel cell stack 20 at the stack's cathode exhaust outlet. During the normal, steady state operation of the fuel cell stack 20, fuel and oxidant are consumed from the fuel and air flows in electrochemical reactions, which are described in Eqs. 1 and 2 above. These electrochemical reactions, in turn, produce electrical power that are converted into the appropriate form (i.e., into the appropriate DC level, AC level, etc.) by a power conditioning subsystem 48 of the fuel cell system 10 before being provided to the load 50.

For the exemplary fuel cell system 10 that is depicted in FIG. 1, the anode exhaust of the fuel cell stack 20 is recirculated through an anode recirculation path 24 back to the fuel source 16 so that unconsumed fuel may be routed back to the anode chamber. Depending on the particular embodiment of the invention, the anode recirculation path 24 may include an active device, such as an exhaust gas blower, or may alternatively include a passive device, such as an ejector device, for example, for purposes of recirculating the unconsumed fuel back to the anode inlet of the fuel cell stack 20.

Not all of the anode exhaust may be re-circulated back to the anode inlet. For example, as depicted in FIG. 1, in accordance with some embodiments of the invention, the fuel cell system 10 may include a fuel bleed flow path between the anode exhaust outlet and the cathode inlet. More specifically, in accordance with some embodiments of the invention, the fuel bleed flow path may be created by an orifice valve 32 that is connected between the anode exhaust outlet and the cathode inlet.

Inert gases may accumulate in the anode chamber over time. If allowed to reach a significant concentration, the inert gases may adversely affect the performance of the fuel cell stack 20. Therefore, in accordance with some embodiments of the invention, the fuel cell system 10 includes a purge flow path that is intermittently opened to purge the inert gases from the anode chamber. As shown in FIG. 1, the purge flow path may be formed from a series combination of a purge valve 34 (a solenoid valve, for example) and an orifice valve, which is connected between the anode exhaust outlet and the cathode inlet of the fuel cell stack 20. This configuration also enables ensuring the hydrogen emission at the outlet of the system to be less than one fourth of the lower explosive limit (LEL) due to the steady fuel consumption by the oxidant at the cathode chamber before the exhaust.

As depicted in FIG. 1, the fuel cell system 10 includes a controller 40, which has various input terminals 41 for purposes of receiving sensed currents, voltages, temperatures and other values; commands, messages from other controllers and/or components of the fuel cell system; etc. Additionally, the controller 40 has various output terminals 43 for purposes of controlling various motors, valves, subsystems, etc. of the fuel cell system 10. In general, the controller 40 may be formed from one or more microprocessors and/or microcontrollers and may be formed from one or more independently-acting controllers, depending on the particular embodiment of the invention. For purposes of simplicity, the controller(s) of the fuel cell system 10 is/are depicted by the single controller 40 in FIG. 1, with it being understood that a single controller or multiple controllers may be used, depending on the particular embodiment of the invention.

In general, the controller 40 controls the overall operation of the fuel cell system 10, including the system's operation during the startup of the fuel cell stack 20; the system's normal, or steady state operation, outside of the startup and shutdown operations; and the system's operation during shutdown of the fuel cell stack 20. Furthermore, as described herein, the controller 40 is part of a control subsystem that controls the fuel cell system 10 to inhibit carbon corrosion during the fuel cell stack's startup and shutdown.

Among its other features, the fuel cell system 10 may include a coolant subsystem (not shown in FIG. 1) to regulate a temperature of the fuel cell stack 20, as well as other valves, motors, circuits, sensors, etc., related to the control and operation of the fuel cell system 10.

For purposes of promoting the electrochemical reactions inside the fuel cell stack 20, each membrane electrode assembly of the fuel cell stack 20 has a platinum catalyst that is supported by high surface area carbon. Although during the normal steady state operation of the fuel cell stack 20, the carbon remains in its ideal solid phase, the dynamics associated with the startup and shutdown of the fuel cell stack 20 may undesirably promote carbon corrosion. Therefore, if not for the features of the fuel cell system 10 that are described herein, these dynamics cause the membrane electrode assembly carbon to change from its solid phase to a gaseous phase (i.e., the dynamics tend to convert the carbon into carbon dioxide (CO₂)). In addition, the platinum can also oxidize to Pt²⁺ and erode out of usable active area. The result of this conversion is that the electrode and the catalyst support of the membrane electrode assemblies may, if not for the features of the fuel cell system 10 described herein, significantly corrode to a degree that causes failure of the fuel cell stack 20.

The above-described carbon corrosion on the cathode side during the startup and shutdown of the fuel cell stack 20 is the result of the front of fuel and oxidant in the stack's anode chamber. The air and fuel front may be present in the anode chamber due to one of the following scenarios. At the beginning of the startup of the fuel cell stack 20, air is generally present in the anode chamber. A fuel-air front develops inside the anode chamber when the fuel is initially communicated to the anode chamber at the beginning of the startup phase. Although the incoming fuel displaces the air, the fuel and oxidant react at the fuel-air front and more specifically, react at the platinum sites at the stack's anode electrodes. The potentials generated at the electrode interfaces provide energy to sustain these reactions at the anode electrodes, and thus, the potentials act as a power supply to produce corresponding reactions at the stack's cathode electrodes. These cathode reactions convert the carbon support at the cathode electrodes into gas (carbon dioxide, for example). A similar effect occurs during the shutdown of the fuel cell stack 20, as a fuel-air boundary forms in the anode chamber after the stack's shutdown due to air leaking/diffusing into the anode chamber. In some cases even at steady state low power operation, recent studies have demonstrated carbon corrosion on the cathode electrode, due to continuous flux of oxygen from the cathode side, but constrained flow of hydrogen to the corresponding catalyst site through the channels and the gas diffusion layer. This in turn, produces the same effect as a front and carbon corrodes at a constant rate, if the blockage at the anode chamber is not removed.

The degree to which carbon corrosion occurs during the stack's startup and shutdown cycle directly impacts the lifetime of the fuel cell stack 20. It is noted that the expected lifetime of the fuel cell stack 20 may need to be relatively high, depending on the stack's application. For example, for embodiments of the invention in which the fuel cell system 10 is part of the power plant for a vehicle, the vehicle (and thus, the fuel cell stack 20) may be started up and shut down several times each day, which may translate into over 18,250 cold (5 cycles per day) startup and hot shutdown cycles during the expected lifetime of the fuel cell stack 20. The fuel cell stack 20 therefore cannot be subject to significant carbon corrosion during each startup and shutdown cycle.

One technique to inhibit carbon corrosion during the startup of a fuel cell stack involves minimizing the residence time in which the fuel-air boundary remains inside the stack's anode chamber. In this technique, a relatively large flow of fuel (a flow that is over ten times the fuel flow during normal operation, for example) is forced into the anode chamber to quickly expel the air from the chamber and minimize the residence time of the damaging front. Another technique that may be used in connection with the shutdown of the fuel cell stack involves a fuel takeover of both the anode and cathode chambers. In this technique, the fuel is introduced into both the cathode and anode chambers of the fuel cell stack when the stack is shut down, and a determination is made of the rate at which leakage occurs from the anode chamber. Thus, additional fuel is supplied to the anode chamber to accommodate the anode chamber leakage to prevent air from entering the anode chamber. Another similar technique to control carbon corrosion includes operating the fuel cell stack as an electrochemical pump when the fuel cell stack is shut down to fill the cathode chamber with fuel. Another technique to control carbon corrosion involves using an external circuit that is connected to the fuel cell stack to lower the electrochemical potentials of the fuel cells' cathode electrodes during the startup and shutdown of the stack.

Significant carbon corrosion may still occur using the above-described techniques, and these techniques may be relatively costly and/or complex to implement. In accordance with embodiments of the invention, which are described herein, the cathode electrodes of the fuel cell stack 20 are “chemically shorted” during the startup and shutdown of the stack 20. In other words, a technique in accordance with embodiments of the invention involves promoting a chemical reaction using a mixture of the fuel and oxidant (the same damaging constituents now not damaging due to the well-formed mixture prior to entering the electrode) inside the fuel cell stack 20 to limit the potential of the stack's cathode electrodes. The lowered potentials, in turn, inhibit the unfavorable reactions at the cathode electrodes, which otherwise corrode the carbon support. [0031 ] More specifically, in accordance with embodiments of the invention described herein, a fuel, such as hydrogen (as a non-limiting example), is introduced into the cathode chamber during the startup or shutdown of the fuel cell stack 20. As a specific example, the volumetric flow rate of the introduced hydrogen and/or an air flow that is mixed with the hydrogen is regulated to keep the fuel-air mixture below the lower flammability limit. In accordance with some embodiments of the invention, the volumetric flow rate of the introduced fuel is four percent or less of the volumetric flow rate of the air flow entering the cathode chamber. The fuel and oxidant (air) react inside the cathode chamber to produce currents that lower the potentials of the cathode electrodes. The chemical shorting inhibits the carbon corrosion by reducing the cathode electrode potentials during startup and shutdown of the fuel cell stack 20.

As a more specific example, in accordance with some embodiments of the invention, existing components of the fuel cell system 10 may be operated to route the fuel-air mixture to the cathode chamber during the startup and shutdown of the fuel cell stack 20. For example, in accordance with some embodiments of the invention, during the startup and shutdown of the fuel cell stack 20, the controller 40 opens the purge valve 34 to communicate a fuel bleed flow from the anode exhaust outlet to the cathode inlet. The flow rate of air into the cathode chamber is adjusted (by adjusting the speed of an air blower of the air source 12, for example) to keep the fuel-air mixture in the cathode chamber below the lower limit of flammability. It is noted that by using existing components of the fuel cell system 10, the cost/complexity of the carbon corrosion control is minimal, as essentially only the software of the controller 40 may be updated with instructions that are executed by the controller 40 for purposes of allowing the chemical shorting. It is noted that in accordance with other embodiments of the invention, however, the fuel cell system may contain components that are dedicated to establishing the flows for the chemical shorting.

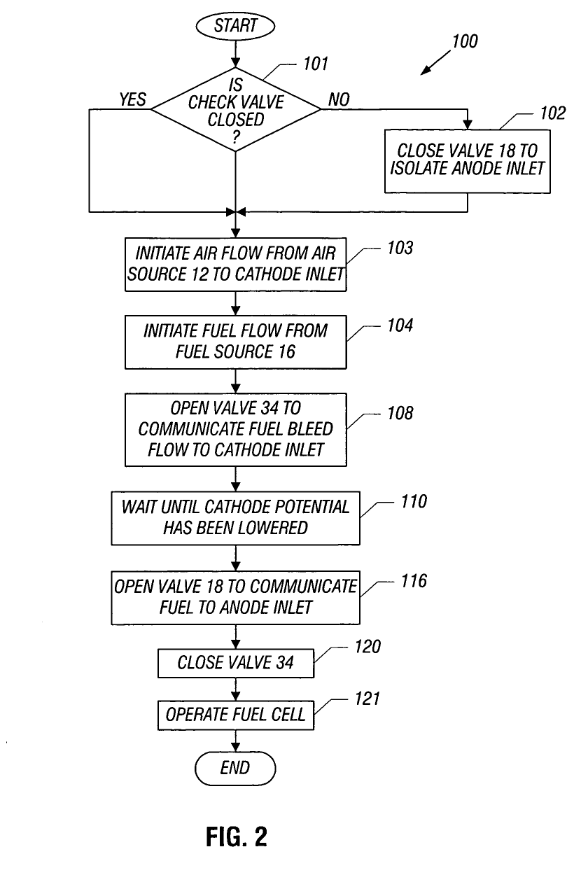

Referring to FIG. 2 in conjunction with FIG. 1, in accordance with some embodiments of the invention, the controller 40 performs a technique 100 during the startup of the fuel cell stack 20. Pursuant to the technique 100, the controller 40 checks for valve closure (diamond 101), and if the valve is closed when not energized, the controller 40 suspends the operation of valve 18. If the valve is open when not energized, the controller 40 operates the valve 18, pursuant to block 102, to close the valve 18 for purposes of isolating the anode chamber of the fuel cell stack 20 from the fuel source 16 and thus, isolating the anode chamber from any incoming fuel flow. It is noted that the anode exhaust of the fuel cell stack 20 is also sealed off from any fuel entering the anode chamber through the anode exhaust outlet via a check valve 22. Next, the controller 40 controls the air source 12 to initiate the appropriate air flow from the air source 12 to the cathode inlet, pursuant to block 103. It is noted that block 103 may involve increasing the rate of air flow from the air source 12 above the rate that exists during the normal steady state operation of the fuel cell stack 20. The controller 40 then initiates a fuel flow from the fuel source 16, pursuant to block 104. As a more specific example, this initiation may include the controller 40 opening a fuel delivery solenoid valve (not shown) of the fuel source 16.

The controller 40 subsequently opens the purge valve 34 to communicate a fuel bleed flow to the cathode inlet path, pursuant to block 108. Thus, the reducing and oxidizing agents are mixed prior to entering the cathode chamber. It is noted that the incoming fuel pressure is maintained slightly higher than the cathode blower exit pressure to maintain the fuel flow to the cathode chamber.

The fuel and oxidant are “well mixed” before the corresponding mixture enters the cathode chamber. As can be appreciated by one of skill in the art, such parameters as flow densities and length and size of the conduit leading to the cathode inlet are selected for purposes of ensuring adequate mixing of the fuel and oxidant flows before the mixture enters the cathode chamber. Thus, a fuel and oxidant mixture, instead of a fuel-oxidant front, enters the cathode chamber.

Due to the fuel-air mixture being provided to the fuel cell stack 20, the chemical shorting begins to suppress the cathode potentials and thus, inhibit carbon corrosion.

After the purge valve 34 is opened to communicate the fuel bleed flow to the cathode inlet, the technique 100 includes waiting (block 110) until the cathode potential has been lowered. As specific examples, the waiting may involve using a timer to measure a predetermined delay (five seconds, as a non-limiting example) for the cathode potential to be lowered. As another example, the waiting in block 110 may be based on a cumulative cell voltage threshold that is measured by a cell voltage monitoring circuit (not shown). Thus, many variations are contemplated and are within the scope of the appended claims.

After the delay imposed by block 110, the controller 40 opens the valve 18, pursuant to block 116, to communicate fuel to the anode inlet of the fuel cell stack 20. The communication of the fuel through the anode chamber of the fuel cell stack 20 eventually displaces any air in the anode chamber and removes the fuel-air front. However, during the residence time in which the fuel-air boundary exists, the above-described chemical shorting lowers the potential of the cathode electrodes to inhibit carbon corrosion. After a sufficient time has passed for the fuel-air front to move through the anode chamber, the controller 40 closes the purge valve 34, pursuant to block 120 and proceeds towards steady state operation (block 121).

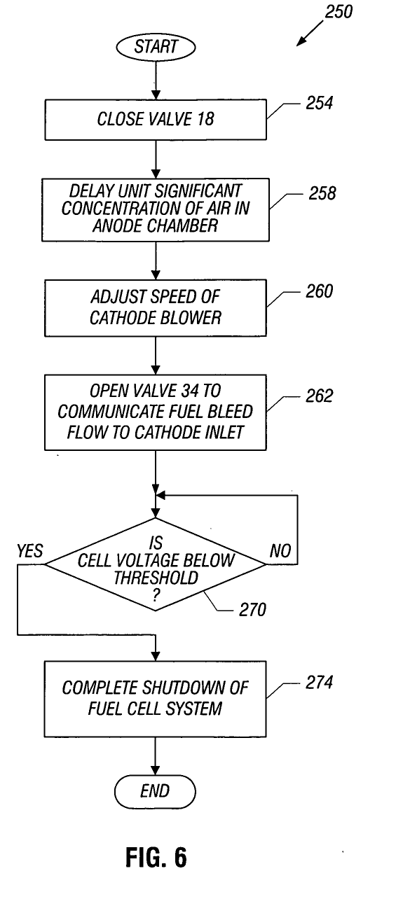

Referring to FIG. 6 in conjunction with FIG. 1, in accordance with embodiments of the invention, the controller 40 may operate pursuant to a technique 250 for purposes of inhibiting carbon corrosion during the shutdown of the fuel cell stack 20. Pursuant to the technique 250, the controller 40 closes the valve 18 (pursuant to block 254) to shut off the fuel flow to the anode chamber. Thus, at this point, the fuel that promotes the electrochemical reactions is limited, and as a result, the fuel cell voltages begin to decay as the limited supply of fuel is consumed. During this time period, air enters the anode chamber, which develops a fuel-air boundary in the chamber, which promotes carbon corrosion at the cathode electrodes. However, the chemical shorting control may not begin immediately when the fuel supply to the anode chamber is shut off. Instead, in accordance with some embodiments of the invention, the controller 40 may take certain power conservation concerns into account.

More specifically, during the shutdown, electrical devices of the fuel cell system 10 (such as an air blower of the air source 12, for example) continue to operate. Therefore, energy may be drawn from a battery (not shown in FIG. 1) of the fuel cell system 10 during this period. Because the chemical shorting (which may be associated with an increased energy drain from the battery due to an increased air blower speed) is not needed until a significant amount of air enters the anode chamber, the technique 250 includes delaying (block 258) the beginning of the chemical shorting until a significant concentration of air enters the anode chamber. This delay, in turn, conserves power that is otherwise drawn from the battery.

After the delay, the controller 40 adjusts (increases, for example) the speed of the air blower, pursuant to block 260, to establish the appropriate air flow to ensure that the fuel-air mixture does not exceed the lower flammability limit. The controller 40 then opens (block 262) the purge valve 34 to initiate the fuel bleed flow to the cathode inlet and thus, the chemical shorting begins. The chemical shorting proceeds until a determination is made (diamond 270) by the controller 40 whether the cell voltage is below a certain threshold (a fuel cell voltage between 0 and −0.2 volts, as a non-limiting example). It is noted that this determination may be made by examining an average fuel cell voltage of the stack, a selected fuel cell voltage, the average of a selected group of cell voltages, etc. The controller 40 may monitor the cell voltages through a cell voltage monitoring or scanning circuit, which is not depicted in FIG. 1. Upon determination that the cell voltage has decreased below the threshold, the controller 40 completes the shutdown of the fuel cell system, pursuant to block 274 and turns off any remaining power-up components of the fuel cell system 10.

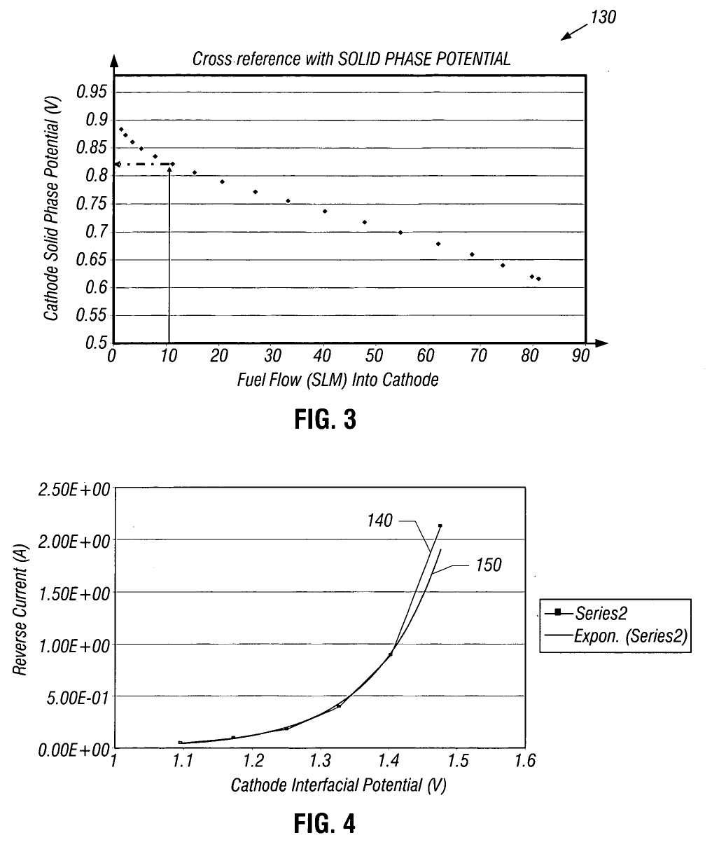

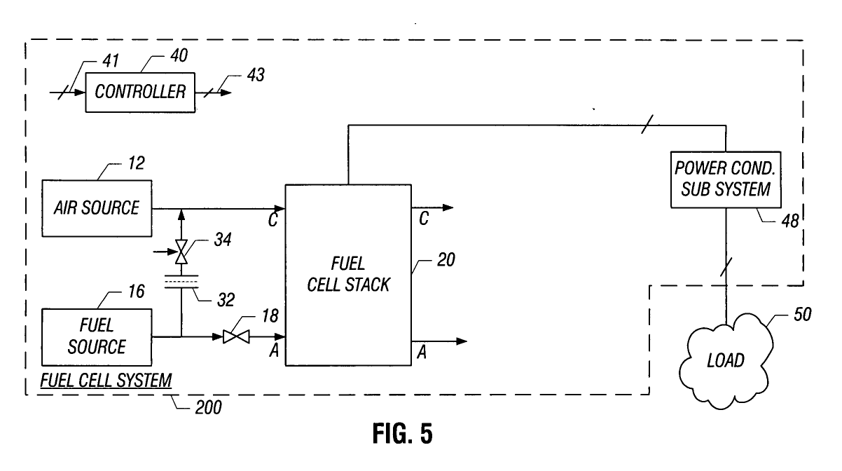

FIG. 3 depicts a graph 130 of a cathode interfacial potential versus a fuel flow (in standard liters per minute (SLM)) into the cathode. In particular, FIG. 3 depicts an exemplary operating point that is achieved through the use of chemical shorting, and has a phase potential less than 820 millivolts (mV) corresponding to low fuel flow-oxidant mixture condition. As shown in FIG. 3, in general, the cathode solid phase potential decreases with the fuel flow into the cathode, and as described in connection with FIG. 4 (described below), the carbon corrosion rate grows exponentially with the potential of the cathode electrode. Thus, in general, increasing the fuel flow into the cathode chamber decreases the carbon corrosion. To comply with the lower flammability limit, the fuel flow into the cathode is maintained at a volumetric flow rate that is approximately four percent or less of the volumetric flow rate of the air through the cathode. Therefore, the limiting factor as to the volumetric flow rate of the fuel into the cathode during the chemical shorting may be determined by the flow capacity of the air blower. Thus, in accordance with some embodiments of the invention, the fuel flow that is provided to the cathode during the chemical shorting depends on the maximum flow rate of air that can be provided by the cathode air blower.

Referring also to FIG. 4 in conjunction with FIG. 3, in general, the reverse current (i.e., the current that promotes carbon corrosion) follows an exponential graph 150. FIG. 4 depicts a graph 140 of measurements of the reverse current for certain cathode interfacial potentials. As can be appreciated by one of skill in the art, reducing the cathode solid phase potential by even 50 mV (as depicted in the exemplary operating point shown in FIG. 3), significantly lowers the carbon corrosion current.

It is noted that factors other than the cathode potential affect the rate at which the carbon corrodes. More specifically, during the startup of the fuel cell stack 20, the stack 20 is relatively “cold” and during the shutdown of the stack 20, the stack 20 is relatively “hot.” Therefore, more energy is available to promote carbon corrosion during the stack's shutdown than during its startup. Thus, a given cathode electrode potential reduction may result in significantly less carbon corrosion in the shutdown of the fuel cell stack 20 than in the startup of the stack 20.

Many variations are contemplated and are within the scope of the appended claims. For example, many different fuel cell types and fuel cell system architectures may be used, in accordance with other embodiments of the invention. As another non-limiting example, FIG. 5 depicts a fuel cell system 200 in accordance with other embodiments of the invention. The same reference numerals have been used in FIG. 5 to denote components that are similar to those described above in connection with the fuel cell system 10 of FIG. 1. However, unlike the fuel cell system 10, the fuel cell system 200 does not include an anode recirculation path, an anode purge path or a fuel bleed path from the anode exhaust. Instead, in the fuel cell system 200, the anode exhaust may be, for example, vented to a flare or oxidizer (not shown).

As shown in FIG. 5, for the fuel cell system 200, the fuel bleed flow path for the chemical shorting is created at the anode inlet. More specifically, in accordance with some embodiments of the invention, the orifice valve 32 has an inlet that is connected to the outlet of the fuel source 16, upstream of the valve 18. The purge valve 34, in turn, is connected in series with the orifice valve 32, and the outlet of the purge valve 34 is connected to the cathode inlet. Thus, during the startup or shutdown of the fuel cell stack 20, the controller 40 opens the valve 34 for purposes of routing fuel from the fuel source 16 to the cathode chamber.

Experiments were conducted using a miniature test stack of eight fuel cells using no carbon corrosion control, the chemical shorting described herein and conventional carbon corrosion techniques for purposes of evaluating the time the cathode electrode potential remained above 1.2 volts and 1.4 volts. The electrode potential was determined by the use of reference electrode and in our case, a Reversible Hydrogen electrode was attached to the study system. Such a Reversible Hydrogen Electrode may be incorporated into either fuel cell system 10 (FIG. 1) or the fuel cell system 200 (FIG. 5) for purposes of allowing the controller 40 to monitor the fuel-oxidant front on the anode through, for example, a cell voltage monitoring device. However, by just providing a redox mixture to the cathode electrode, the electrode potential is fixed and acts as a reference point and the cell voltage measured along can be used to infer the anode potential. The results of the experiments are depicted in Table 1 below.

TABLE 1

| | | Time > | | Time > | |
|---|---|---|---|---|---|
| | | 1.2 V secs | | 1.4 V secs | |
| | Number of | | Std. | | Std. |
| | Samples | Mean | Dev. | Mean | Dev. |
| Standard Startup | 12 | 12.073 | 0.911 | 8.505 | 1.404 |
| 7.19 H2 Bleed Cathode | 4 | 0.000 | 0.000 | 0.000 | 0.000 |
| 7.27 15.35 SLM Flow | 5 | 1.460 | 0.114 | 0.880 | 0.228 |
| Composite Shutdown | 14 | 13.355 | 0.685 | 10.094 | 0.951 |
| 7.19 H2 Bleed Cathode | 5 | 7.440 | 1.227 | 4.289 | 1.826 |

Referring to Table 1, for the scenario in which no carbon corrosion technique was used, the cathode potential remained above 1.2 volts for a mean of 12.073 seconds, and the cathode potential remained above 1.4 volts for a mean of 8.5 seconds. For a carbon corrosion control technique in which fuel was forced at a high rate through the anode chamber for purposes of rapidly removing the fuel-air boundary, the electrode potential remained above 1.2 volts for a mean of 1.460 seconds and remained above 1.4 volts for a mean of 0.880 seconds. These two techniques are to be contrasted to the chemical shorting technique for which the cathode electrode potential remained below 1.2 volts during the stack's startup period.

Table 1 also depicts the performance of the chemical shorting for the shutdown of the stack in comparison with hydrogen takeover. As shown, for the hydrogen takeover, the electrode potential remained above 1.2 volts for a mean of 13.355 seconds and remained above 1.4 volts for a mean of 10.094 seconds. For the chemical shorting technique, the cathode electrode potential remained above 1.2 volts for a mean of 7.44 seconds and remained above 1.4 volts for a mean of 4.289 seconds.

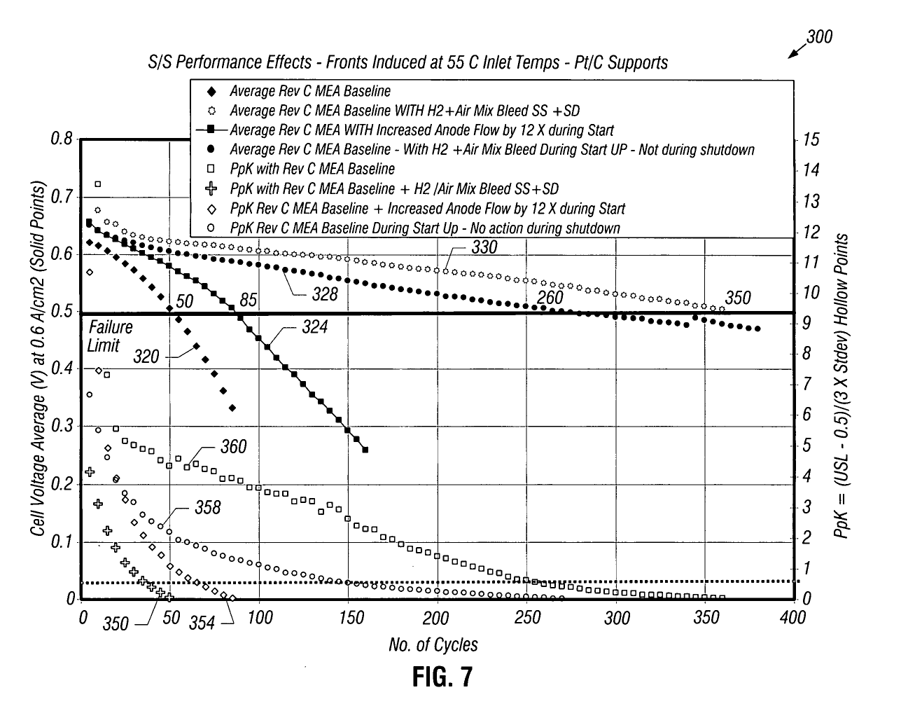

FIG. 7 depicts graphs 300, which illustrate the performance of the chemical shorting technique described herein. An accelerated testing protocol (a protocol that subjected the fuel cell stack to significantly harsher conditions than expected “real life” conditions) was chosen to show the fix effectivity of the fuel—oxidant mixture mitigation. The fuel cell temperature was fixed to be 55° C. and fronts were induced during both the shutdown and start-up front for this accelerated protocol. In particular, FIG. 7 depicts graphs 320, 324, 328 and 330 of cell voltages versus the number of startup and shutdown cycles. Also depicted in FIG. 7 is a horizontal line 310, which depicts a cell voltage of 0.5 volts, a voltage for which the stack is deemed to have failed. The graph 320 shows that after 50 startup/shutdown cycles, the test stack failed, as the cell voltage decreased below 0.5 volt threshold. The graph 324 depicts the cell voltage versus a number of cycles for a technique that increased the anode flow 12 times during the startup of the stack. As shown, the decreased residence time due to this carbon corrosion technique extended the stack life to 85 cycles. The graphs 328 and 330 depict the application of the chemical shorting techniques that are described herein, which significantly extended the lifetime of the stack. More specifically, the graph 328 depicts the cell voltage average versus number of cycles when chemical shorting was used during the startup of the stack but was not used during the shutdown of the stack. As shown, the stack had a lifetime of 260 cycles. As depicted in the graph 330, when chemical shorting was used for both the startup and shutdown, the lifetime of the stack was extended to 350 cycles. The realization of a seven fold increase in the start-stop capability is just with a mere low fuel flow-oxidant scenario, whereas an increase greater than seven fold is expected when the cathode potential is reduced significantly lower than the 820 m V with a higher fuel flow-oxidant mixture.

Graphs 350, 354, 358 and 360 in FIG. 7 depict a performance variability index for various carbon corrosion techniques. In general, the performance variability index shows the variability in the degradation of cells in the same stack. A higher performance variability index means that the fuel cells of the stack degrade more uniformly, as compared to a lower performance variability index in which cells more non-uniform degradation occurs. A stack is considered defective when a single defective cell drops below the 0.5 volt threshold. Thus, a higher performance variability index is preferred and an indication of uniform degradation across all cells.

As depicted in the graph 350 of FIG. 7, when no technique was used to limit carbon corrosion, the performance variability index was the lowest. The next lowest performance variability index occurred, as depicted by the graph 354, for the technique in which a 12 times volumetric anode flow was provided to the anode chamber during the stack's startup. The highest performance variability occurred, as depicted by graphs 358 and 360, when chemical shorting was used. In particular, as depicted by the graph 358, the performance variability index significantly increased when the chemical shorting was used during the startup and increased even more, as depicted by the graph 360, when chemical shorting was used during both the startup and shutdown of the fuel cell stack.

Other embodiments are within the scope of the following claims. For example, in other embodiments of the invention, the chemical shorting may be used to adjust the potential of the anode electrode during the startup and shutdown for purposes of inhibiting carbon corrosion. In this manner, during the startup/shutdown of the fuel cell stack, air may be introduced with fuel into the anode chamber while the volumetric air and fuel flow rates are regulated to comply with the lower limit of flammability. Thus, many variations are contemplated and are within the scope of the appended claims.

There may be a number of side benefits to using the chemical shorting that is described herein. For example, in accordance with some embodiments of the invention, approximately 1200 Watts (W) of thermal energy may be available due to the fuel-oxidant mixture reaction in the cathode chamber at the low fuel flow condition. Significantly higher thermal energy can be obtained with higher fuel flow condition. Therefore, this thermal energy may be used for purposes of quickly warming up the fuel cell stack from a freezing environment and may be used for rapidly thawing the fuel cell stack, in accordance with some embodiments of the invention.

Additionally, the chemical shorting may be used for purposes of humidifying the fuel cells. In this regard, in accordance with some embodiments of the invention, a water flow rate of 0.13 grams per second is available for fuel cell humidification for purposes of humidifying the fuel cell membranes at relatively low flow rates of fuel and oxidant mixtures.

The chemical shorting may also be used for purposes of suppressing the electrochemical potential of the cathode of the fuel cell stack, when needed in special cases, apart from starting and shutting down. As an example, the chemical shorting has the capability to suppress the cathode electrode potentials without electrical current in the external circuit, which makes the chemical shorting technique useful for purposes of a dormancy startup protocol. More specifically, the chemical shorting may be used for purposes of mitigating dormancy related performance losses, by removing any adsorbed species on the platinum electrode. Since it is required to suppress the electrochemical potential of the cathode electrode to clean the electrode surface, the typical method includes generating electrical current and dumping load to the external circuit, namely customer site, and running at high power to reduce the cathode potential. In this regard, typically, the fuel cell stack may be expected to deliver power to a load. However, if the power that is demanded by the external load, namely the customer site, is lower than the power that is required to enable reduction in cathode electrochemical potential to clean the catalyst surface, there may be no other place to dump energy. This creates high reliance on the customer site load and constrains any performance recovery that can be obtained on a timely basis. However the electrochemical potential suppression caused by the chemical shorting only causes heat which can be dumped into the thermal management system. So the chemical shorting gives independence from the customer site bus when needing to recover performance of a fuel cell after a prolonged dormancy. This degree of freedom enables embedded timer based controls that will ascertain the chemical shorting for a pre-set duration after start-up to recover performance losses of the fuel cell stack. During steady state power generation, the purge valve 34 can be kept open to reduce the cathode potential to guarantee corrosion-free operation at low power operation. Many other benefits, advantages and/or other uses of the chemical shorting are contemplated and are within the scope of the appended claims

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method usable with a fuel cell, comprising:
providing a fuel and oxidant mixture to a reactant chamber of a fuel cell to control an electrode potential of the fuel cell during startup or shutdown of the fuel cell.

2. The method of claim 1, wherein the act of providing comprises:
providing the fuel and oxidant mixture to a cathode chamber of the fuel cell.

3. The method of claim 2, wherein the act of providing the fuel and oxidant mixture to the cathode chamber comprises:
combining a first flow of oxidant with a second flow of fuel, the second flow having a volumetric rate that is approximately four percent of a volumetric rate of the second flow.

4. The method of claim 1, wherein the act of providing comprises:
controlling an anode potential of the fuel cell during the startup or shutdown of the fuel cell, comprising providing the fuel and oxidant mixture to an anode chamber of the fuel cell.

5. The method of claim 1, wherein the act of providing comprises reducing the electrode potential of the fuel cell during the startup or shutdown.

6. The method of claim 1, wherein the act of providing inhibits carbon corrosion from a membrane electrode assembly of the fuel cell.

7. The method of claim 1, wherein the act of providing comprises:
initiating an oxidant flow to a cathode of the fuel cell during the startup of the fuel cell; and
after initiating the oxidant flow, initiating a fuel flow to a cathode of the fuel cell.

8. The method of claim 1, further comprising:
waiting for the fuel and oxidant mixture to lower the electrode potential before a fuel flow is provided to an anode chamber of the fuel cell.

9. The method of claim 8, wherein the waiting comprises monitoring the electrode potential or measuring a predetermined delay interval.

10. The method of claim 1, further comprising:
initiating the oxidant flow;
initiating a fuel flow to an inlet anode flow path to the fuel cell during the startup of the fuel cell while preventing the fuel flow from entering an anode chamber of the fuel cell; and
after the initiation of the fuel flow, initiating a fuel bleed flow between the inlet anode flow path and an inlet cathode flow path.

11. The method of claim 1, wherein the act of providing comprises forming the fuel and oxidant mixture outside of the reactant chamber and communicating the mixture formed outside of the reactant chamber into the reactant chamber.

12. The method of claim 1, further comprising:
halting a fuel flow to an anode chamber of the fuel cell to shut down the fuel cell; and
subsequently mixing a fuel flow with an oxidant flow to a cathode of the fuel cell to form the mixture; and
providing the mixture to the cathode until a voltage of the fuel cell decreases below a predetermined threshold.

13. The method of claim 1, further comprising:
using the act of providing the fuel and oxidant mixture to transfer heat to the fuel cell to warm up the fuel cell from a freezing environment or rapidly thaw the fuel cell.

14. The method of claim 1, further comprising:
using the act of providing to humidify the fuel cell.

15. The method of claim 1, further comprising:
using the act of providing the fuel and oxidant mixture to suppress a cathode electrochemical potential of the fuel cell after the fuel cell has been dormant.

16. The method of claim 1, further comprising:
providing a dynamic reference electrode at the cathode electrode due to the mixture of fuel and oxidant; and
using the dynamic reference electrode to estimate an anode potential during front movement through the fuel cell.

17. A system comprising:
a fuel cell stack; and
a control subsystem to control electrode potentials of fuel cells of the fuel cell stack during startup or shutdown of the fuel cell stack, wherein the control includes providing a fuel and oxidant mixture to a reactant chamber of the fuel cell stack during the startup or shutdown.

18. The system of claim 17, further comprising:
a reverse hydrogen reference electrode to designate a cathode potential as a reference electrode,
wherein the control subsystem uses the reference electrode to monitor a progression of a fuel-air front through the reactant chamber.

19. The system of claim 17, wherein the control subsystem comprises a controller and at least one control valve.

20. The system of claim 17, wherein the control subsystem is adapted to control cathode potentials of the fuel cells during the startup or shutdown of the fuel cell stack, including providing the fuel and oxidant mixture to a cathode chamber of the fuel cell stack.

21. The system of claim 17, wherein the control subsystem is adapted to control cathode potentials of the fuel cells during steady state low power generation of the fuel cell operation of the fuel cell stack, including providing the fuel and oxidant mixture to a cathode chamber of the fuel cell stack.

22. The system of claim 17, further comprising:
a vehicle engine to receive power from the fuel cell stack.

23. The system of claim 17, further comprising:
a stationary load to receive power from the fuel cell stack.

24. The system of claim 17, wherein the control subsystem controls carbon corrosion from membrane electrode assemblies of the fuel cell stack.

25. The system of claim 17, wherein the control subsystem comprises:
a first valve to communicate fuel from a fuel source to an anode chamber of the fuel cell stack; and
a second valve to communicate fuel to a cathode chamber of the fuel cell stack.

26. The system of claim 25, wherein the second valve is connected to receive fuel from an anode exhaust of the fuel cell stack.

27. The system of claim 25, wherein the first valve is adapted to receive fuel from the fuel source.

28. The system of claim 17, wherein the fuel cell stack comprises direct methanol, direct ethanol, phosphoric acid or PEM fuel cells.
